(19) United States
(12) Patent Application Publication
(10) Pub. No.: US 2010/0199867 A1
(43) Pub. Date: Aug. 12, 2010

(54) DISCHARGING OF PRINTING INK

(76) Inventors: Lothar Kuhlmeyer, Darmstadt (DE); Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/668,175

(22) PCT Filed: Jul. 3, 2008
(86) PCT No.: PCT/EP2008/005413

§ 371 Date: Feb. 11, 2010

(30) Foreign Application Priority Data
Jul. 11, 2007 (DE) 10 2007 032 598.5
Jun. 24, 2008 (DE) 10 2008 029 998.7

(51) Int. Cl. B41F 31/00; B41F 33/00

(52) U.S. Cl. 101/349.1; 101/483

(57) ABSTRACT

A sheet-fed printing press having an inking unit with ink applicator rolls for supplying ink to a plate cylinder and a damping unit having a damping solution applicator roll for supplying damping solution to the plate cylinder. The ink applicator rolls and damping solution rolls each are movable between thrown on and off positions relative to the plate cylinder. A control device is provided for predetermining a number of de-inking sheets that can be imprinted with an ink image while the ink applicator rolls and damping solution applicator rolls are in a thrown off position without ink being supplied from the inking unit. The control device is carried out as a function of prepress data or inline measured data. The printing press may also include a lacquering unit which is operable in thrown on or off positions during passage of said predetermined number of de-inking sheets.

### CROSS-REFERENCE TO RELATED APPLICATIONS

This patent application is the national phase of PCT/EP2008/005413, filed Jul. 3, 2008, which claims the benefit of German Patent Application Nos. 102007032598.5, filed Jul. 11, 2007, and 102008029998.7, filed Jun. 24, 2008.

### FIELD OF THE INVENTION

The present invention relates generally to sheet fed printing presses, and more particularly to a printing press having an improved system for cleaning printing cylinders without disassembly or removal from the press.

### BACKGROUND OF THE INVENTION

During printing, a printing stock is moved through printing units, wherein in each printing unit, a partial printed image is applied from a printing plate, perhaps via a printing blanket of a printing blanket cylinder, onto the printing stock. In the case of a combined colored print, the printing stock is usually moved through at least four printing units so as to apply onto the printing stock partial printed images in the scale colors black, cyan, magenta, and yellow. In additional printing units, partial printed images can be applied onto the printing stock in special colors. Finally, one or more coatings can also be applied on printed images produced in such a manner so as to produce protective effects, to produce structures, or to produce glossy or matte effects.

As inking units, conventional Heber inking units, film-type inking units, or anilox inking units can be used in the offset printing process. Furthermore, it is also possible to use combinations of such inking units within the printing press. In offset printing units, damping units can also be used, which are used to supply the damping solution onto planographic printing plates clamped on plate cylinders so that only the image areas can be wetted with printing ink. Damping units are omitted in the so-called dry offset printing, which is carried out with special printing plates.

On such printing presses, a function called de-inking is known. De-inking is used when one of the printing plates is to be freed from printing ink, without having to wash it, that is, without having to clean it at a high cost. In a washing process, the entire inking unit associated with the individual printing plate would also have to also be washed. During de-inking, however, only a certain number of printing sheets are transported through the printing units without supplying printing ink to the printing plate, wherein the printing units are moved in the thrown-on position, and thus, the printing sheets which are just then passing through largely remove the residual ink which is present on the printing plate and the printing blanket. The printing plate is also cleaned in the case of the de-inking process so that without causing additional soiling of machine components or of operating personnel, it can be dismantled or removed from the pertinent printing unit. The number of printing sheets to be used for the de-inking can be adjusted in accordance with values from experience by the operator at a control station of the printing press, wherein the position of the printing plate to be cleaned within the printing press can be taken into consideration. The same is true for a function called delacquering, comparable to de-inking. In this case, a lacquer form cylinder of a lacquering machine or a lacquering unit integrated into a printing press is freed from excess lacquer by sheets that pass through the printing press after the actual printing or coating process. Here too, the number of printing sheets to be used is preselectable. The cleaning of the lacquer form cylinder is then substantially less expensive.

In this regard, a process and a device for regulating the layer thickness of an ink film for a multicolor printing press are known from EP 0 983 852 B1. This publication takes into consideration that plate cylinders are provided in printing units and hold a printing plate which carries the printing image, wherein such printing plates must be replaced. The printing plates are to be supplied in different ways with printing ink. In this connection, the proposal is made that in the printing units where a printing plate is to be replaced, a selectable number of printing sheets be used up in printing with switched-off ink supply at the printing unit. This results in a reduction in the ink layer thickness on the inking rolls of the inking unit so that the switch to a new inking profile is facilitated. The corresponding printing plates are thereby only conditionally cleaned, however, since they—even if in a reduced amount—are further supplied with printing ink by the inking units. Therefore, during a plate change, the printing plates continue to be soiled, especially since in normal inking units, for example, for offset printing presses, a relatively large quantity of ink is stored on a large number of inking rolls.

To minimize a residual lacquer layer thickness on a lacquer roll and on one or each lacquer form positioned on a form cylinder, after carrying out a throwing off in printing units, a procedure is already known, from DE 33 12 128 A1, as to how to determine via a control device a number of printing sheets that should still be supplied to a corresponding lacquering unit before a throwing off. It is hereby left open as to how the lacquer roll and the form cylinder are adjusted. Therefore, in the disclosed lacquering unit, the situation can occur that during a so-called pre-lacquering, when switching the lacquering unit from a thrown-off position to a thrown-on position, and in the so-called delacquering, when switching the lacquering unit from the thrown-on position to the thrown-off position, printing sheets are printed, only partially, with a lacquer image. Printing sheets that are only partially provided with a lacquer image are useless and must be removed as spoiled sheets.

Basically, therefore, after every application change, a decision has to be made as to how printing plates for repeat applications are to be disposed of. In this respect, printing plates can be removed by the plate changer, cleaned or covered with ink before the removal via the inking unit, so as to be cleaned manually externally. The plate changing elements thereby soil prematurely.

### OBJECTS AND SUMMARY OF THE INVENTION

It is an object of the present invention to provide an improved apparatus and method for operating printing, lacquering, and inking units in a printing press in a manner which facilitates cleaning of the plate cylinders without removal from the press.

In accordance with the invention, processes for de-inking or delacquering are derived from adjustment data that is available in a system or a device for the prepress stage processing for a printing application, among others, for the production of needed printing plates. From data available from prepress stage data with regard to a surface covering, a sort of paper, and printing inks used and from a known number of printing sheets, the optimal number of printing sheets to deink the printing plate or printing plates is calculated by a control computer of the printing press or within the printing press. In accordance with the invention, the printing unit of the printing press that has the largest degree of soiling determines the total number of needed de-inking sheets. These are marked as spoiled sheets.

For this purpose, the following measures are suitable:
Marking in the stack, using a strip inclusion detector.
Detectable individual markings, using a printing device.
Discharging of the de-inking sheets into a sheet distributing guide/double stack delivery device.

In keeping with the invention, falling short of a certain ink density can be measured on the printed sheet with devices for inline ink density measurement during the de-inking, and the paper supply on the feeder can be stopped. An automatic control system for the measurement of the ink density on the printing sheets provides control signals, by means of which the number of needed de-inking sheets is determined. The printing unit that has the greatest degree of soiling on the printing plates of the plate cylinder and on the printing blankets of the printing blanket cylinders can be selected automatically in this way so that at the end of the application, the de-inking can automatically expire as a result of a control with reference to a printing run counter and in accordance with the number of accepted printed sheets.

Likewise, the de-inking or delacquering can also take place before attaining a selected printing run level. Then, the individual process is introduced by a purposeful interruption of the continuous printing process from the control station of the printing press. Subsequently, the printing press can be restarted or continued with cleaned printing plates and printing blankets.

The same previously described measures can be undertaken with delacquering. The number of delacquering sheets can be determined by the data with reference to a cup volume of the screen roll, the type of lacquer used, and the lacquer form (depending on whether suitable for full-surface or for spot lacquering) and the number of lacquered sheets. The screen roll and its specific data can then be identified via logistic data or integrated RFID systems. Alternately, the number of lacquering sheets can be determined by means of inline lacquer layer thickness measurement so that falling short of a minimum lacquer layer thickness will stop the paper supply on the feeder.

In presses with inline lacquering, the two processes can be carried out in one operation. The printing or lacquer module for which the highest number of lagging sheets is calculated determines the actual number of these sheets.

In accordance with the selected work principle, the processes of the paper supply to the printing press and the throwing off of the application rolls from the form cylinder, or the separation of the form cylinder relative to the impression cylinder, are linked with one another in such a way that a printing plate clamped on the form cylinder is largely cleaned at the end of a printing application and the printing process itself finished at that time. The supply of printing ink to the printing plate is thereby interrupted by the throwing off of the ink applicator rolls, so that, in the thrown-on position of the printing unit, only residual ink from the printing plate or the printing blanket cylinder can still be printed. Thus, an ink image is printed with steadily diminishing ink application on a number of spoiled sheets, wherein these spoiled sheets produced shortly before the throwing off can be discharged from the production process.

According to the process with preadjustment from prepress stage data or an inline measurement excess spoiled sheets are no longer produced. The residual soiling of the plate or of the lacquer form is minimized. The preselection of the number of de-inking sheets or delacquering sheets is omitted. Thus, operating errors are avoided and the preparation time is shortened.

What is advantageous in this process is that the ink layer still present on the surface of the printing plate is very quickly reduced by the interaction of the form cylinder and the printing blanket cylinder by diverting to the printing stock printed on the printing blanket cylinder. The ink layer is reduced by the individual half-splitting of the residual layer to very small layer thicknesses.

Many additional operations can be omitted with other handling advantages:
1. The printing blanket cylinder is largely free of ink and need no longer be cleaned with a washing apparatus or with a great expenditure of time.
2. The printing plates are almost free of ink and can be replaced without any problem by means of an automatic plate changer without soiling it.
3. Unlike the cleaning via inking units, detergent particles do not collect in the plate capillaries.

With a flying plate change in printing presses with individual drives, the de-inking via discharged sheets is possible in individually selected printing units.

Therefore, an ink removal from the printing plate after the end of a production order is provided so as to be able to take away printing plates without inserting a washing operation and without soiling of automatic plate changers.

With a thrown-on printing blanket cylinder, the ink and damping solution applicator rolls are thrown off the plate cylinder at a precalculated time of a certain number of sheets before the final throwing off or at a time determined by measurement technology. Preferably, in accordance with the invention, a simultaneous throwing off of ink and damping solution applicator rolls is provided since in the throwing off of the ink applicator rollers, a smaller ink absorption and thus a worse cleaning effect was determined. The delayed or separate throwing off of the damping solution applicator rolls can nevertheless be done for special subjects, printing stocks, or printing inks.

Furthermore, on a printing press that has one or more lacquering units for the additional coating of the printing sheets, the throwing off of the lacquering units can take place, at least staggered relative to the throwing off of the ink or damping solution applicator rolls within the framework of the de-inking. A delacquering thereby also is provided. This should, however, take place only if the ink quantity still present on the plate cylinder and the printing blanket cylinder is minimized so that in the lacquering unit(s), a re-splitting of the printing ink from the printing sheets on lacquer forms or printing blankets is avoided in the lacquering units.

Preferred refinements of the invention can be deduced from the following description. An embodiment of the invention will be explained in more detail, without being limited to the example or embodiment.

A printing press has a sheet feeder and, in the area of the printing units, at least one inking unit and, downstream from the printing units, a sheet delivery device. Usually, several printing units are connected one after the other. Printing sheets that are to be printed are moved through the printing press via several sheet-conducting cylinders, wherein some sheet-conducting cylinders are designed as transfer cylinders and others, as impression cylinders. In the area of the inking units, a transfer cylinder or printing blanket cylinder rolls on the impression cylinder. A form cylinder carrying at least one printing plate or a plate cylinder, in turn, work together with the printing blanket cylinder. By means of an inking unit with ink applicator rolls and perhaps a damping unit with damping solution applicator rolls, printing ink and, perhaps beforehand, damping solution are applied on the printing plate or on each printing plate positioned on the plate cylinder. To this end, the ink applicator rolls and damping solution applicator rolls can be thrown on and off relative to the plate cylinder, into a position thrown on the printing plate or into a position thrown off the printing plate. The printing ink is applied onto the printing sheet held on the impression cylinder in each printing unit as a monochrome partial printing image via the printing blanket cylinder.

The printing sheets, printed with a complete printed image in the printing units and perhaps refined in a lacquering unit with a colored or clear surface layer, are conveyed via a conveyance system from the printing press and laid on one another on a delivery device stack in the sheet delivery device.

The plate cylinders have clamping devices for printing plates which are to be positioned on the plate cylinder. An automatic plate changer is preferably associated with the plate cylinders and by means of this changer, the supply and removal of fresh or used printing plates on the plate cylinder is possible.

According to one aspect of the invention, the throwing off of at least the ink applicator rolls from the plate cylinder at the end of the production takes place before the end of the sheet run or transport of the printed sheets during a printing application. Plate cylinders, printing blanket cylinders, and impression cylinders, however, still remain in contact with one another.

This makes it possible to attain a situation at the end of a printing application in which the printing sheets moving through the printing press still remove printing ink via the printing blanket cylinder from the plate cylinder, without printing ink being supplied by the inking unit to the printing plate. Thus, a residual ink layer is quickly removed from the printing blanket and plate cylinder or the printing plate. The printing plate, which becomes clean in this way, can be removed without any danger of soiling via the automatic plate changer, and a new printing plate can be supplied.

The throwing on and off of ink applicator rollers and the plate or printing blanket cylinder is carried out via adjustment elements, which can be controlled by a control device, with reference to the work position of the printing press. Depending on the speed of the press, corresponding lead times or lead angles are provided so that the adjustment elements react in a timely manner.

The process of de-inking can be carried out with damping units thrown off from the printing plates or with thrown-on damping units. The operating mode can be selected and is dependent on the printing stocks used, the printing ink used, the type of printing plates, or the surface cover of the subject on the individual printing plates. Therefore, provision is also made so that different printing plate treatments are possible in different printing units of the printing press.

One further adjustment possibility is that the damping unit remains thrown on with the production rpm for the time the de-inking sheets are passing through. Subsequently, it can be thrown off. Individual damping units, however, can also be thrown off. Furthermore, a so-called permanent damping solution removal can be selected so that each of the damping units can no longer be thrown off if the de-inking process expires—that is, the de-inking in all used printing units must expire with a thrown-on damping unit.

Via the control device, it is possible to determine a number of printing sheets that, after throwing off the ink applicator rolls, are still printed with an incomplete ink image by means of the residual ink still present on the printing blanket cylinder and the printing plate. The number of printing sheets can be determined so that after the final throwing off each printing form positioned on the plate cylinder has a defined residual ink layer thickness and is thus actually cleaned. With this process designated as de-inking, ink images are printed with a diminished ink application, wherein this is caused by the decreasing ink layer thickness, since the supply of ink to the printing plate and the printing blanket cylinder from the inking unit is cut off. Thus the surfaces of the printing blanket and printing plate are extensively cleaned and the danger of drying of the printing ink is avoided.

Sheet-fed printing presses are also known in which plate cylinders are provided with so-called individual drives mechanically separated from the other drives of the printing press. In such a printing press, a so-called flying plate change is possible, in which with the aid of the individual drives, the replacement of printing plates is also possible on individual, selected plate cylinders. The other printing plates remain on the corresponding plate cylinders so that only a partial image of the total printed image is replaced. Such a procedure may be defensible if partial image contents—for example, explanations in constantly changing languages—are to be imprinted into an otherwise static ink image. The plate change process taking place in the flying plate change corresponds to an ordinary plate change, wherein the replacement of a certain printing plate and the subsequent use of this printing unit take place for the subsequent continued printing.

The procedure is slightly changed for the flying plate change since a delay in the printing process may occur so as to be able to again start the pertinent printing unit. The advantages of the process, however, are also applicable for the individual printing unit with individual drives.

Again, the ink applicator rolls are thrown off beforehand with this function and the excess printing ink remaining on the printing blanket and the plate cylinders is already removed during the slow-down of the printing press before the flying plate change, without introducing additional spoiled printing sheets from the selected printing unit. However, since spoiled sheets already normally occur during the slow-down of the printing press, they can be used directly for the de-inking.

For cleaning of printing plates to be conveyed from the printing unit, most of the residual ink still present is removed by means of spoiled sheets. To this end, with a thrown-on printing blanket cylinder, the ink and damping solution applicator rolls are thrown off at the time of a preselectable number of sheets before the final throwing off of the plate cylinder. Preferably, with the procedure in accordance with the invention, a simultaneous throwing off of ink and damping solution applicator rolls is implemented. In actual practice, it was determined that a throwing off of the ink applicator rolls while the damping solution applicator rolls are still thrown on resulted in a small ink removal by the printing sheets from the printing blanket cylinder and also between the plate cylinder and printing blanket.

The delayed or separate throwing off of the damping solution applicator rolls can be a desirable procedure for special subjects, printing stock, or printing inks. The prolonged damping of the printing plate can be advantageous if another cleaning effect on the printing plate is desired with respect to soilings of a type other than those coming from printing ink. This is possible for subjects with a low ink overlay or covering or for printing stock that causes dust. Furthermore, certain printing inks can tend to re-splitting, which can be avoided with a prolonged damping of the printing plate.

The de-inking process also is adaptable when it is carried out on a printing press equipped with one or more lacquering units for the coating of the printing sheets. Then, the de-inking process can be carried out alone or can be combined with a delacquering process. Preferably, the throwing off of the lacquering units take place at least in staggered relation to the throwing off of the ink or damping solution applicator rolls. This makes it possible for the spoiled sheets to still be covered sufficiently during the de-inking with lacquer or coating medium. This avoids a situation where moist printing ink present on the spoiled sheets can split back onto a lacquer plate mounted on a lacquer form cylinder of the lacquering unit or a correspondingly placed printing blanket, and can soil it in an undesired manner. In a simplified embodiment, a lacquer applicator roll in the lacquering unit can be thrown off from the lacquer form cylinder. Thus, a clearly more rapid reaction is attained than if the lacquer supply was thrown off. Thus, a re-splitting of printing ink on elements of the lacquering unit is avoided and a precisely controllable removal of the residual lacquer from the lacquering unit is made possible.

The delacquering should therefore take place only if the ink quantity still present on the plate cylinder and the printing blanket cylinder has been minimized. Therefore, a predetermined number of printing sheets pass through the printing press for the removal of printing ink with thrown-off ink and perhaps damping solution applicator rolls, with a printing blanket cylinder thrown on at the plate and impression cylinder, whereas the lacquering unit(s) are still functioning and a re-splitting of the printing ink by the printing sheets on lacquer forms or printing blankets in the lacquering units is avoided. Only subsequently need a predetermined number of additional printing sheets be conveyed through the printing press and the lacquering units for the removal of the still present residual lacquer or residual coating medium in the lacquering units.

The processing steps in a known printing unit with an inking and damping solution unit may be defined as follows:
Preparation of a certain number of spoiled sheets in the feeder.
Pre-selection of a number of spoiled sheets on the printing press.
Any application-related storage of the parameters.
Throwing off of the application rolls in accordance with preselection of spoiled sheets.
Removal of the printing ink by the printing blanket via the conveyed spoiled sheets pre-selected by the printing press.
Removal of the printing ink from the printing plate with the printing blanket cylinder via spoiled sheets conveyed through the printing press.
Throwing off of the lacquer supply in the lacquering units delayed so as to avoid re-splitting of the printing ink by spoiled sheets in the lacquering units, wherein perhaps the lacquering applicator roll in the lacquering unit is thrown off.
Perhaps, removal of the residual lacquer from the lacquer plate/printing blanket in the lacquering unit via the spoiled sheets conveyed through the printing press.
Removal of the printing plates without additional cleaning from the printing units.
Perhaps removal of the lacquer plates to be changed without additional cleaning.

In accordance with the invention, process data for the inking or delacquering then continue to be obtained from the adjustment data, which are available in a prepress stage device for a printing application and in particular, as data related to the printing image, such as on a printing plate. Such data can be deposited and evaluatable in a work preparation station or a control station of a printing press.

Data for the application of the printing images or partial printing images are obtained from the aforementioned prepress stage data for the preadjustment of printing presses. Such data can refer to parameters regarding a surface covering, a type of paper, and printing inks used. Therefore, since it is already known how to ink the printing plates (with regard to the surface coverage of the image fractions, ink acceptance behavior of the types of paper, coverage behavior of the printing ink), the process-related cleaning parameters for the printing plates to be deinked and/or for the lacquer plates to be cleaned of the lacquer can be deduced from this data and from a known number of sheets printed beforehand in the printing application. In this respect, the optimal number of printing sheets for the de-inking of the printing plate or printing plates is calculated by a control computer, which is associated with the printing press or is present within the printing press itself.

In keeping with the invention, the printing unit of the printing press that has the greatest degree of soiling determines the total number of de-inking sheets needed. These printing sheets manifest themselves as spoiled sheets because of the insufficient de-inking as a result of the throwing off of the ink supply and must be separated from the good sheets in or after the delivery of the sheets.

The following measures are suitable for this:
So that the de-inking sheets in the stack can be easily identified, they are marked by a so-called strip inclusion detector within the delivery device stack.
De-inking sheets can be provided individually with markings, for example, by an ink jet printing apparatus (marking). In this way, during a further processing, the de-inking sheets can be found with suitable detectors and removed.
For the removal of the de-inking sheets, a so-called sheet distributing guide can be used on their transport path to the sheet delivery unit, which serves to remove individual printing sheets from the sheet flow.
The separation of the de-inking sheets can also take place in a double stack delivery unit on a separate laying down stack.

A refinement of the above described process in accordance with the invention can consist of determining the number of de-inking sheets needed by means of a device for inline ink density measurement, or by means of inline sheet inspection systems, perhaps including an image analysis, on the printing or spoiled sheets used for the de-inking. Here, the ink or lacquer coverage of the work units to be evaluated at the end of a printing application as soiling is determined from the printing process with the aid of specific data and is used in defining of the de-inking or delacquering process.

By such procedure if during the de-inking process a certain ink density value on the de-inking sheets is not found, the paper supply to the feeder is stopped. Then, the cleaning of the printing plate is regarded to be sufficient. To this end, merely the function for the de-inking need be selected by the operating personnel and the control of the printing press independently generates the process steps of the de-inking with the selection of the required de-inking sheets and the individually required switching of the printing units during the de-inking.

To this end, a control loop is set up. By measuring the ink density present on the de-inking sheets, control signals are generated that determine the number of de-inking sheets needed or make possible the further supply of printing sheets and de-inking sheets. The printing ink or the printing unit with the greatest degree of soiling on plate and printing blanket cylinders is automatically selected. This can, in turn, take place with the aid of prepress stage data or with the aid of adjustment of the ink metering, wherein a large supply of ink also means a great degree of soiling in the printing unit or on the printing plate.

At the end of the printing application and with the aid of the data of a printing run counter of the printed good sheets, the de-inking process can be started and can take place fully automated within a defined application structure.

The same previously described measures can be undertaken during the delacquering for cleaning of a lacquer form of excess lacquer, by printing sheets that pass through the printing press after the printing process or in a controlled manner during interruptions of a printing process. The number of delacquering sheets can be calculated by the lacquer quantity dependent on the cup volume of the screen roll, the type of lacquer, and the kind of lacquer form, which can be designed full-surface or for spot lacquering, and the number of printing sheets lacquered during the printing application. The operating data addressed here is likewise, as described in connection with the printing units, a component of the application data, which is deposited in a work preparation station or a control station of a printing press. The data of the used screen roll can also be identified, alternatively, via logistics data or via an RFID system.

As an alternative to the previously described process, it is possible to determine the number of delacquering sheets via an inline lacquer layer thickness measurement. Accordingly, the paper supply at the feeder can be stopped once a certain minimum lacquer layer thickness is not met.

Likewise, the de-inking or delacquering also can take place before attaining a selected printing run level. Then, the individual process is introduced by an intentional interruption of the continuous printing process by the control station of the printing press. Subsequently, the printing process can be restarted or continued with cleaned printing plates and printing blankets. The printing interruption can then be connected with the press control so that the automatically or manually preselected de-inking of the printing plates or delacquering of the lacquer module(s) takes place. To this end, a pre-selection mode can also be provided, by means of which it is possible to dictate whether the printing press is shut down without a de-inking or delacquering process. Likewise, the adjustment can be carried out automatically if certain conditions, such as the ink application, paper tending to soiling, or sensitive printing inks, are present. In turn, this can also take place in connection with measuring devices (preferably, arranged inline) to record ink densities or for sheet inspection.

Both processes can be carried out in presses with inline lacquering in one operation. The printing or lacquer module for which the highest number of lagging sheets is calculated determines the actual number of de-inking and delacquering sheets. The combination of de-inking and delacquering takes place with reference to avoiding ink re-splitting into the lacquering unit, as described above. Likewise, the combination of the throwing off of ink and damping solution applicator rolls in accordance with the process is undertaken as also described above.

Other objects and advantages of the invention will become apparent upon reading the following detailed description and upon reference to the drawings, in which:

### BRIEF DESCRIPTION OF THE DRAWINGS

FIGS. 1 and 2 represent alternative embodiments of sheet-fed offset printing presses operable in accordance with the invention.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DESCRIPTION OF THE PREFERRED EMBODIMENTS

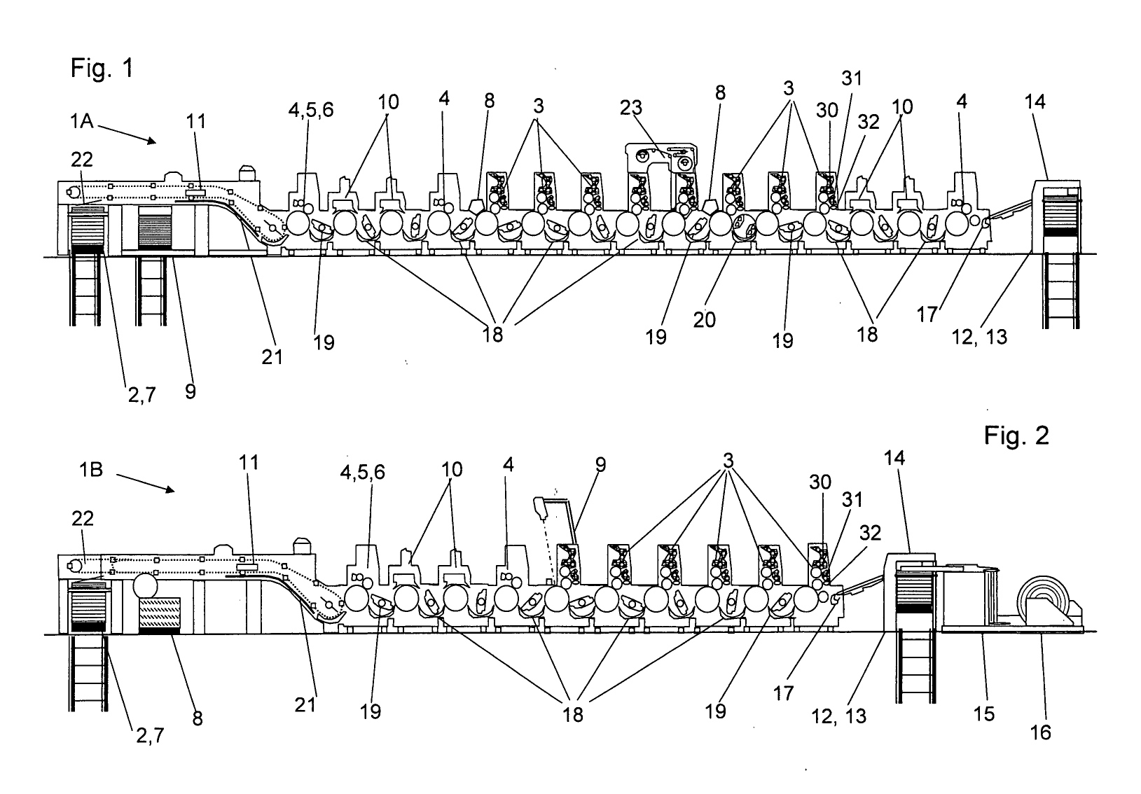

Referring now more particularly to the drawings, FIGS. 1 and 2 depict two alternative embodiments of sheet-fed offset printing presses operable in accordance with the invention. Similar numbers have been used to depict similar components of the two illustrated printing presses. The illustrated printing presses, designated 1A and 1B in FIGS. 1 and 2, respectively, each include several printing units 3, at least one lacquering unit 4 and perhaps other further processing units in the form of punching, cutting, or embossing units 5, and numbering or calendaring units 6 are provided. Furthermore, a cold foil unit 23 for the transfer of a metal foil layer onto printing stock within two printing units 3 can be provided.

To supply the printing units 1A, 1B with printing stock, a stack conveyor 12 is provided in connection with a feeder 14 and a stack transport system 13 with automatic sheet supply for the printing press 1A. For discharging of printing sheets by each of the printing presses 1A, 1B, a stack conveyor 2 is provided in connection with a delivery unit 22 and a corresponding stack transport system 7. The supply of sheets can take place underlapped from a reel-sheet feeder to the feeder 14 by means of a supply reel 16 and a transverse cutter 15, as depicted in FIG. 2.

The printing units 3 are designed as offset printing units for automatic operation. To this end, devices are provided by means of which all adjustments and the supply with operating materials can take place without manual intervention.

The printing units 3 of the printing presses 1A, 1B have automatic inking units 30 and damping units 31. The latter are equipped with devices for remote-controllable and regulatable adjustment of Heber cycles, trituration inserts and strokes, selectable roll separation and thrown-off positions, variations of the ductor rpm, etc.

Alternatively, the plate cylinders (form cylinders) of the printing presses 1A, 1B are provided with a direct drive, independent of the main drive, in the printing units 3. When using such a drive configuration, a simultaneous plate change and/or simultaneous wash functions and/or simultaneous advance inking programs and/or a flying application change can be carried out by means of corresponding controls.

Furthermore, one or more lacquering units 4 are upstream, between, or downstream, relative to the printing units 3, in the printing press 1A, 1B. The construction style can be designed as a lacquering module or inline lacquering unit on the printing unit. Moreover, lacquering units are provided an automatic lacquer supply that includes the tempering of the lacquer and/or a viscosity regulation system for the lacquer.

Also, automated printing plate change devices are provided for the plate and form cylinders in the printing units 3 and, perhaps, in the lacquering units 4 of the printing presses 1A, 1B. Printing plates can be easily replaced during the application change by means of these devices. In addition, automated washing devices 32 for the rubber blankets, inking units, damping units, printing cylinders, form cylinders and the lacquer circuit are provided in the printing units 3 and lacquering units 4 of the printing presses 1A, 1B.

The sheet transport through the printing press 1A, 1B takes place in the printing unit by means of automated ventilator paths 18, transfer drums 19, and sheet guidance systems, and in the delivery unit by means of sheet guidance paths 21. A so-called turning device 20 is provided in the printing press 1A.

To dispose of spoiled sheets or for the distributed layout, a sheet distribution device 8 or a double delivery device 9 is provided. For a reliable and smear-free layout, a powder sprayer 11, which is related to the printing subject or the sheet format, and an end drier 10 and intermediate drier are provided.

Quality monitoring takes place by means of inline inspection systems 9 in a printing press 1B and/or inline densitometry devices 8. They can be placed, optionally, as an inline ink density measuring and regulating device or as an inspection system, before and after a sheet turning device, so as to monitor both sides of the printing stock and to be able to evaluate them.

Finally, the press control station is equipped with the storage functions for all printing press and order-related adjustment and measurement values so that they can be recalled for repeat orders or actual evaluations. The press control station and the press control are also characterized by an integration into a printing network with the prepress stage, logistics, supply of materials, other printing presses, and the preliminary and continued processing. To monitor the printing process and the printing order data, a sheet counter and a spoiled sheet counter are used. Also, consumption data recording for all materials (for example, printing ink, damping solution, lacquer) needed in the printing process are provided. In this way, printing process-relevant and order-relevant data are obtained, which also include disturbances and adjustment corrections.

For quality monitoring during the printing production, automated processes are used, in that inline—that is, during the printing within the printing press 1A,1B—the ink densities are measured and, perhaps, the sheets are simultaneously subjected to a defect inspection. In connection with the ink measurement and regulation, automatic damping is carried out by subsequent supply of the damping solution as a function of the inking and the individual operating state of the printing press and external parameters. Finally, a control with regard to the coating with lacquer also takes place. With inline lacquering, a lacquer layer thicken measurement is used for this purpose.

For printing presses 1A with a turning device 20, in which printing stock is imprinted on the front and back sides, an ink coordination is preferably carried out for the front and back sides of the printing sheets by means of a double measuring and regulating system 8. The front side of the page is measured before the turning of the sheet 20 and after the end of the back-side printing, the image of the back side is evaluated. To this end, a double inline inspection system is provided, which is automatically coupled with the regulation device of the printing press 1A for the case of the turning operation.

For the performance of the printing press 1A, 1B, it is important to provide automated washing processes for the inking unit, the rubber blanket, the printing cylinders, and the form cylinders in the printing units 3. These processes can be triggered, in accordance with the invention, by quality monitoring of the printing production, in particular during the de-inking or delacquering. For the cleaning of at least one cylinder and/or at least one roll of a printing press 1A, 1B, the printing run is interrupted or ended. Then, a cleaning program is started and after the end of the cleaning, with an interrupted printing run, it is continued, or a preparation is carried out with an ended printing run. Processes for the preparation of the cleaning can be carried out with a continuous printing run, wherein the actual cleaning program is carried out only after the end or an interruption of the printing. Immediately after the end of the cleaning, the printing run can be continued or the preparation can be carried out.

The integration of self-learning processes also can be provided. These have an effect for washing cycles, simultaneous washing, preferably, for example, in connection with stack change processes and measurable state of the soiling of the printing press. To this end, the inline density measuring devices 8 and the inline inspection device 9 are used in connection with the automated inking units 30, damping units 31, and washing devices 32.

1-18. (canceled)

19. A sheet-fed printing press comprising:
a printing unit having at least one inking unit with ink applicator rolls and a plate cylinder carrying at least one printing plate wherein the inking unit transfers printing ink, metered via the ink applicator rolls, onto the printing plate, at least one damping unit including a damping solution applicator roll for supplying a damping solution to the plate cylinder,
said plate cylinder being operable for transferring printing ink supplied from the inking unit applicator rolls from the printing plate directly onto printing sheets moved between the plate cylinder and an impression or indirectly onto printing sheets via a printing blanket cylinder,
said ink applicator rolls and said damping solution roll each being movable between thrown-on and off positions,
a control device having printing application data effective for moving one or both of the ink applicator rolls and the damping solution roll to a thrown off position, and said control device being operable based upon said application data for predetermining a number of de-inking sheets that can be imprinted with an ink image without ink supplied from the ink unit.

20. The sheet-fed printing press of claim 19 in which said control device is operable for moving said printing blanket cylinder to a thrown off position relative to the impression cylinder such that the predetermined number of de-inking sheets can be imprinted with an ink image with the printing blanket cylinder in the thrown off position.

21. The sheet-fed printing press of claim 19 including a lacquering unit having a lacquer applicator roll which is movable from a thrown on to a thrown off position with respect to a lacquer form cylinder, said lacquering unit is operable for applying a coating onto sheets conducted between the lacquer form cylinder and an impression cylinder associated with the lacquer form cylinder when said lacquer applicator roll is in said thrown on position, and said control device is operable for moving said lacquer applicator roll to either a thrown off or thrown on position for a preselected number of sheets determined from printing application data.

22. The sheet-fed printing press of claim 20 in which said damping solution roll and ink applicator rolls can be moved to the thrown off position from the plate cylinder while said printing blanket cylinder is in a thrown on position, and said printing blanket cylinder can be moved to a thrown off position from the plate cylinder and impression cylinder after passage of said predetermined number of de-inking sheets.

23. The sheet-fed printing press of claim 21 in which in which said control is operable for moving said printing blanket cylinder to a thrown off position from the plate cylinder after said ink application rolls are thrown off from the plate cylinder, and subsequently, the lacquer applicator roll can be thrown off the lacquer form cylinder and the lacquer form cylinder can be thrown off from the impression cylinder.

24. The sheet-fed printing press of claim 19 in which said control is operable to determine a number of de-inking sheets to be imprinted with a residual ink image before throwing off of the ink applicator rolls and damping solution rolls.

25. The sheet-fed printing press of claim 19 in which said control is operable for determining the number of de-inking sheets such that after movement of the ink applicator rolls to the thrown off position and printing of said number of de-inking sheets the printing blanket cylinder and printing plates have a predetermined minimal residual ink layer thickness.

26. The sheet-fed printing press of claim 19 in which said control device is operable for automatically reducing a rate of production of the printing press before throwing off of the ink applicator rolls.

27. The sheet-fed printing press of claim 19 in which said control device is operable before throwing off of said ink applicator rolls for determining said number of de-inking sheets to be passed through the printing unit without a supply of ink from the inking unit and a constantly declining application of ink to the de-inking sheets.

28. The sheet-fed printing press of claim 19 in which said control device includes a data collection device for determining the number of de-inking sheets to pass through the printing unit without a supply of ink from the inking unit and a constantly diminishing application of ink and a processing device for processing prepress application data and adjusting the metering of ink from the inking unit.

29. The sheet-fed printing press of claim 19 in which said control device includes a data collection device for determining, prior to throwing off of the applicator rolls, the number of de-inking sheets to pass through the printing press without a supply of ink from the inking unit, and said data collection device being coupled to a measuring device for detecting ink density values of ink on the de-inking sheets and for communicating data with respect to ink density to the data collection device in response to measurement of a minimum ink density.

30. A method for operating a printing press having a printing unit that includes an inking unit and a damping unit in which printing ink is transferred via ink applicator rolls of the inking unit onto a printing plate held on a plate cylinder and from there transferred to printing sheets by a printing blanket cylinder having a printing blanket and damping solution is transferred to the printing plate on the plate cylinder via at least one damping solution applicator roll, and wherein the ink applicator rolls and damping solution applicator roll can be moved between thrown on and thrown off positions relative to the plate cylinder and said blanket cylinder can be moved between thrown on and off positions with respect to an impression cylinder comprising the steps of:
determining a number of de-inking sheets from printing application data, moving the ink applicator rolls to said thrown off position while said blanket cylinder is in the thrown on position, and imprinting said predetermined number of de-inking sheets with said ink applicator rolls in the thrown off position with residual printing ink remaining on the printing blanket and printing plate.

31. The method of claim 30 in which before throwing off of said ink applicator rolls, the number of de-inking sheets to be imprinted with a residual ink image is determined such that after throwing off of the ink applicator rolls and the imprinting of said predetermined number of de-inking sheets the plate cylinder has only minimal residual ink.

32. The method of claim 30 in which the number of de-inking sheets is determined for a time between two periods in which the ink applicator rolls are in a thrown on position.

33. The method of claim 31 in which said printing press includes a lacquering unit which is operable between a thrown on position in which lacquer is applied to printed sheets and a thrown off position which interrupts the supply of lacquer from the lacquering unit, and said predetermined number of de-inking sheets is determined with said lacquering unit in said thrown off position without a supply of lacquer from the lacquering unit.

34. The method of claim 33 in which the number of de-inking sheets is determined during a time between two periods in which the lacquering unit is in a thrown on position.

35. The method of claim 31 including determining the soiling of the printing plate by application data in relation to said determined number of de-inking sheets.

36. The method of claim 30 including operating said damping unit with said damping solution applicator roll in a thrown off position that interrupts the transfer of damping solution to the printing plate during a period said predetermined number of de-inking are processed through the printing press.

37. The method of claim 30 including operating said damping unit with said damping solution applicator roll in a thrown on position during passage of said predetermined number of de-inking sheets through the printing press.
